(19) United States
(12) Patent Application Publication
(10) Pub. No.: US 2026/0103371 A1
(43) Pub. Date: Apr. 16, 2026

(54) LIFT DEVICE AND METHOD FOR CONTROLLING A LIFT DEVICE

(71) Applicant: TEREX SOUTH DAKOTA, INC., Watertown, SD (US)

(72) Inventors: Huang YE, Xinbei Changzhou (CN); Wang ANCANG, Xinbei Changzhou (CN); Du RONGRONG, Xinbei Changzhou (CN); Yang XIAOCHENG, Xinbei Changzhou (CN)

(73) Assignee: TEREX SOUTH DAKOTA, INC., Watertown, SD (US)

(21) Appl. No.: 18/915,825

(22) Filed: Oct. 15, 2024

(51) Int. Cl. B66F 17/00; B66F 11/04

(52) U.S. Cl. CPC B66F 17/006; B66F 11/042; B66F 2700/05

(57) ABSTRACT

A lift device includes a lift mechanism movable to raise or lower a platform relative to a base, a manifold having a valve actuatable to deliver fluid to a hydraulic actuator configured to move the lift mechanism, a motor for driving a pump to deliver fluid to the manifold, an electric power module in communication with the manifold, and a controller in communication with the electric power module. The controller is configured, in the event of a failure of the motor, to activate the electric power module to actuate the valve of the manifold to enable gravity lowering of the platform by the lift mechanism from a first position to a second position below the first position.

### TECHNICAL FIELD

The following relates to a lift device and a method for controlling a lift device.

### BRIEF DESCRIPTION OF THE DRAWINGS

FIG. 1 is a perspective view of a non-limiting exemplary embodiment of a lift device according to the present disclosure;

FIG. 2 is a block diagram of a non-limiting exemplary embodiment of a use case of a lift device according to the present disclosure; and

FIG. 3 is a flowchart of a non-limiting exemplary embodiment of a method for controlling a lift device according to the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, features, and elements have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The present disclosure includes an auxiliary power module capable of lowering an Aerial Work Platform (AWP) of a lift device (e.g., scissor lift, boom lift, or the like) to an access position. The auxiliary power module may be configured to output power during normal mode operations for the AWP and also when emergency operation lowering of the AWP is required. Alternatively, the auxiliary power module may be configured to output power only when emergency operation lowering of the AWP is required. When emergency operation lowering of the AWP is activated, a lowering valve coil will be powered by the auxiliary power module. As a result, the lowering valve will be opened to enable gravity lowering of the AWP.

Thus, present disclosure may be utilized with a mechanical/electrical work platform (MEWP) lift device and may provide an auxiliary system to provide a backup in the event of failure of the primary power (e.g., out of fuel, battery out of charge) that is capable of returning the work platform from anywhere in the working envelope to an access position, and that may have controls located in a position easily accessible from the ground, which controls may alternatively be located or duplicated on the work platform. The present disclosure thereby represents an improvement over current emergency lowering system architectures whereby a lowering valve is opened by pulling a cable connected with the lowering valve spool. Such current architectures therefore require components such as a wire rope cable and cable puller, and also have limitations including good routing of the wire rope cable to the lowering valve spool to avoid interference with other moving parts, as well as a good cable puller mechanism and installation to ease the force required for pulling. Instead, as described herein, the present disclosure provides a type of emergency lowering system for a work platform, such as a scissor lift platform, using an auxiliary power module to electrically power the lowering valve coil whereby electrical activation of the lowering valve coil opens the lowering valve to fulfill the lowering function. The present disclosure thereby eliminates the usage of annoying wire rope cable and related routing and puller installation.

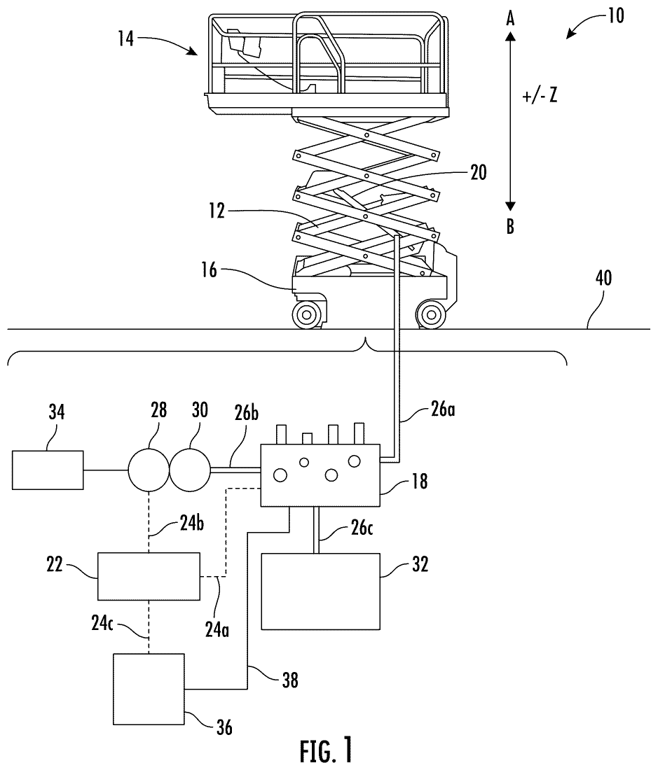

In that regard, FIG. 1 is a perspective view of a non-limiting exemplary embodiment of a lift device 10 according to the present disclosure. As seen therein, the lift device 10 may comprise a lift mechanism 12 movable to raise or lower a platform 14 (which may be an aerial work platform) in a direction +/−Z relative to a base 16. While the lift mechanism 12 shown in FIG. 1 comprises scissor arms, any other known type of lift mechanism (e.g., a boom lift) may alternatively be employed.

The lift device 10 may further comprise a manifold 18 having one or more valves actuatable to deliver fluid to and/or receive fluid from a hydraulic actuator 20 configured to move the lift mechanism 12. In that regard, the one or more valves of the manifold 18 may be actuatable by a controller 22 via one or more control signals transmitted over a communication line 24a. In that same regard, fluid may be delivered to and/or received from the hydraulic actuator 20 via one or more fluid lines 26a. It should be noted that while the hydraulic actuator 20 shown in FIG. 1 is illustrated as a linear actuator, any other known type of hydraulic actuator may alternatively be employed.

The lift device 10 may still further comprise a motor 28 for driving a pump 30 to deliver fluid from a hydraulic fluid tank 32 to the manifold 18 via one or more fluid lines 26b, 26c. The motor 28 may receive power for operation from a power source 34. In that regard, the motor 28 may be an electric motor, gasoline powered motor, diesel fuel powered motor, or any other known type of motor. In addition, motor 28 may be controlled (e.g., speed) by controller 22 via a communication line 24b.

The lift device 10 may also comprise an electric power module 36 in communication with the manifold 18, such as via an electrical power and/or signal line 38. As well, the lift device 10 may further comprise controller 22 in communication with the electric power module 36. In the event of a failure of the motor 28, the controller 22 may be configured to activate the electric power module 36 via a command signal transmitted over one or more communication lines 24c to actuate one or more valves of the manifold 18 to enable gravity lowering of the platform 14 by the lift mechanism 12 from a first position A to a second position B below the first position A. In that regard, the one or more valves may comprise an electrically powered conductive coil (e.g., solenoid valve) (not shown) and the electric power module 36 may actuate the one or more valves of the manifold 18 by delivering electrical power thereto via one or more electrical power and/or signal lines 38. Moreover, the second position B may be a position of the platform 14 that is manually accessible from a surface 40 (e.g., ground) supporting the base, such that an operator located on the platform 14 may exit to the surface 40 in the event of a failure of the motor 28. The electric power module 36 may also be referred to and/or comprise an auxiliary power module and may be configured to output power only in the event of a failure of the motor 28.

As previously noted, the lift mechanism 12 of the lift device 10 may comprises a scissor lift mechanism. As also previously noted, the drive motor 28 of the lift device 10 powered by power source 34 may be an electric motor powered by an electrical power source such as a battery, or a gasoline or diesel motor powered by gasoline or diesel fuel delivered by a fuel delivery system. In that regard, the failure of the motor 28 described above, in the event of which the controller 22 may be configured to activate the electric power module 36, may comprise insufficient battery charge or insufficient gasoline or diesel fuel.

The controller 22 of the lift device 10 may be configured to detect a failure of the motor 28 automatically. The controller 22 may also be configured to automatically activate electric power module 36 in the event of a failure of the motor 28. Alternatively, or in addition, the controller 22 may be manually operated to activate electric power module 36. The lift device 10 and/or the controller 22 may also comprise a display (not shown) to indicate to an operator or another the status of the motor 28 (e.g., failure) and/or the electric power module 36 (e.g., activated or inactive).

As seen in FIG. 1, the manifold 18, controller 22, motor 28, pump 30, tank 32, power source 34, and electric power module 36 may be part of or contained in the base 16 of the lift device 10. Alternatively, the controller 22 may be located on the platform 14, such as for manual operation by an operator of the lift device 10. The controller 22 may alternatively, or in addition, be located remotely from the lift device 10 and may be provided in communication with the lift device 10, including the electric power module 36, either wirelessly or via a wired connection, such as for operation by an operator.

In that regard, the controller 22 may be configured as a distributed component that may be duplicated on or distributed between the lift device 10 (e.g., platform 14) and a remote location. As one skilled in the art would understand, the controller 22, as well an any other system, unit, machine, apparatus, element, sensor, detector, device, component, subsystem, arrangement, or the like described herein may individually, collectively, or in any combination comprise appropriate circuitry, such as one or more appropriately programmed processors (e.g., one or more microprocessors including central processing units (CPU)) and associated memory which may include stored operating system software and/or application software executable by the processor(s) for controlling operation thereof and/or for performing the particular algorithms represented by the various functions and/or operations described herein, including interaction and/or cooperation between any such controller, system, unit, machine, apparatus, element, sensor, detector, device, component, subsystem, arrangement, or the like. One or more of such processors, as well as other circuitry and/or hardware, may be included in a single component (e.g., an ASIC (Application-Specific Integrated Circuit)), or several processors and various circuitry and/or hardware may be distributed among several separate components, whether individually packaged or assembled into a SoC (System-on-a-Chip).

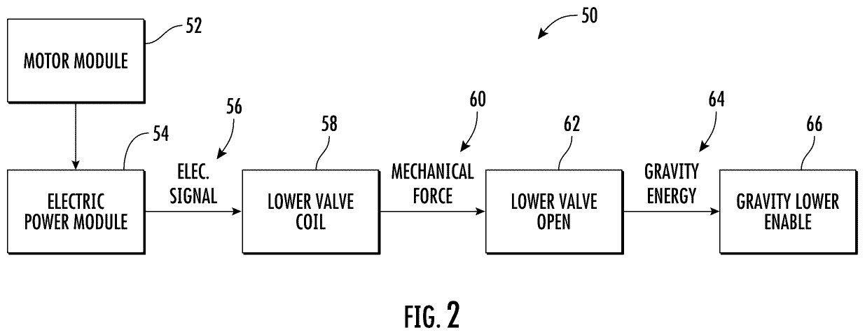

FIG. 2 is a block diagram of a non-limiting exemplary embodiment of a use case 50 of a lift device 10 according to the present disclosure. More specifically, FIG. 2 illustrates a function diagram of a use case 50 for emergency lowering of the platform 14 of the lift device 10 by the electric power module 36 in the event of a failure of the motor 28. The electric power module, which may be referred to and/or comprise an auxiliary power module, acts or serves as a power source to provide electrical power to a lowering valve coil when emergency lowering of the platform 14 is required. When the lowering valve coil is electrically powered, an electric-magnetic force produced by lowering valve coil will pull the lowering valve spool to an open status position. Thereafter, with the lowering valve spool in an open position, the lowering function of the lift device 10 will be activated due to the effect or force of gravity. As seen therein, and with continuing reference to FIG. 1, as previously described, in the event of a failure 52 of the motor 28, the electric power module 36 (which may be referred to and/or comprise an auxiliary power module) may be activated 54 and provide and/or transmit electrical power and/or an electrical signal 56 to one or more valve coil(s) of manifold 18 that is/are involved in a lowering function 58 wherein a fluid flow from actuator 20 will lower (−Z) the platform 14 of the lift device 10. As a result, a mechanical force opens 62 such one or more valve(s) (e.g., solenoid valve(s)). Consequently, due to the weight of the platform 14, the force of gravity 64 thereby enables lowering 66 of the platform 14 from a first position A to a second position B at a location below position A.

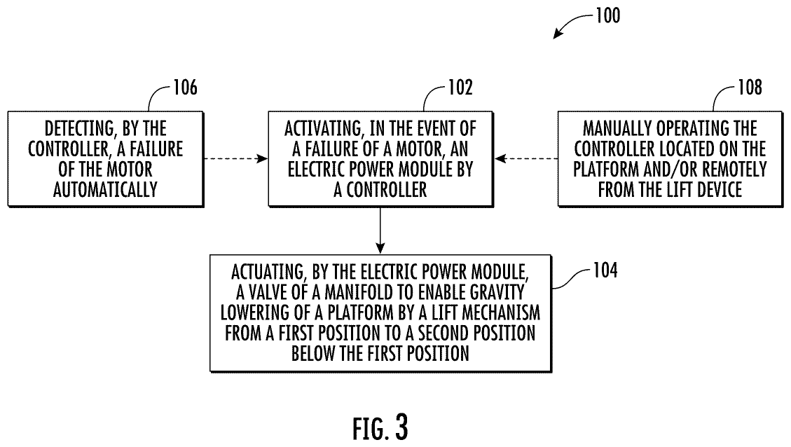

FIG. 3 is a flowchart of a non-limiting exemplary embodiment of a method 100 for controlling a lift device according to the present disclosure. As seen therein, and with continuing reference to FIGS. 1 and 2, the method 100 may be provided for controlling a lift device 10 having a lift mechanism 12 movable to raise or lower a platform 14 relative to a base 16, a manifold 18 having a valve actuatable to deliver fluid to a hydraulic actuator 29 configured to move the lift mechanism 12, a motor 28 for driving a pump 30 to deliver fluid to the manifold 18, an electric power module 36 in communication with the manifold 18, and a controller 22 in communication with the electric power module 36.

The method 100 may comprise activating 102, in the event of a failure of the motor 28, the electric power module 36 by the controller 22, and actuating 104, by the electric power module 36, the valve of the manifold 18 to enable gravity lowering of the platform 14 by the lift mechanism 12 from a first position A to a second position B below the first position A. The method 100 may further comprise detecting 106, by the controller 22, a failure of the motor 28 automatically. Moreover, activating 102 the electric power module 36 may itself comprise manually operating 108 the controller 22.

With continuing reference to FIGS. 1-3, the present disclosure also provides a non-transitory computer readable storage medium having stored computer executable instructions for controlling a lift device 10 having a lift mechanism 12 movable to raise or lower a platform 14 relative to a base 16, a manifold 18 having a valve actuatable to deliver fluid to a hydraulic actuator 20 configured to move the lift mechanism 12, a motor 28 for driving a pump 30 to deliver fluid to the manifold 18, an electric power module 36 in communication with the manifold 18, and a controller 22 in communication with the electric power module 36, wherein, the instructions when executed cause the controller 22 to activate, in the event of a failure of the motor 28, the electric power module 36 to actuate the valve of the manifold 18 to enable gravity lowering of the platform 14 by the lift mechanism 12 from a first position A to a second position B below the first position A. The instructions when executed may also cause the controller 22 to detect a failure of the motor 18 automatically.

Item 1: In one embodiment, the present disclosure provides lift device comprising a lift mechanism movable to raise or lower a platform relative to a base, a manifold having a valve actuatable to deliver fluid to a hydraulic actuator configured to move the lift mechanism, a motor for driving a pump to deliver fluid to the manifold, an electric power module in communication with the manifold, and a controller in communication with the electric power module, wherein, in the event of a failure of the motor, the controller is configured to activate the electric power module to actuate the valve of the manifold to enable gravity lowering of the platform by the lift mechanism from a first position to a second position below the first position.

Item 2: In another embodiment, the present disclosure provides the lift device of Item 1 wherein the lift mechanism comprises a scissor lift mechanism.

Item 3: In another embodiment, the present disclosure provides the lift device of any of the preceding Items wherein the controller detects a failure of the motor automatically.

Item 4: In another embodiment, the present disclosure provides the battery system of any of the preceding Items wherein the hinged element is formed from the insulator.

Item 5: In another embodiment, the present disclosure provides the lift device of any of the preceding Items wherein the controller is manually operable and is located on the platform and/or remotely from the lift device.

Item 6: In another embodiment, the present disclosure provides the lift device of any of the preceding Items wherein the second position is manually accessible from a surface supporting the base.

Item 7: In another embodiment, the present disclosure provides the lift device of any of the preceding Items wherein the electric power module comprises an auxiliary power module and outputs power only in the event of a failure of the motor.

Item 8: In another embodiment, the present disclosure provides the lift device of any of the preceding Items wherein the drive motor is battery powered and a failure of the motor comprises insufficient battery charge, or the drive motor is gasoline powered and a failure of the motor comprises insufficient gasoline, or the drive motor is diesel fuel powered and a failure of the motor comprises insufficient diesel fuel.

Item 9: In another embodiment, the present disclosure provides a method for controlling a lift device having a lift mechanism movable to raise or lower a platform relative to a base, a manifold having a valve actuatable to deliver fluid to a hydraulic actuator configured to move the lift mechanism, a motor for driving a pump to deliver fluid to the manifold, an electric power module in communication with the manifold, and a controller in communication with the electric power module, the method comprising activating, in the event of a failure of the motor, the electric power module by the controller, and actuating, by the electric power module, the valve of the manifold to enable gravity lowering of the platform by the lift mechanism from a first position to a second position below the first position.

Item 10: In another embodiment, the present disclosure provides the method of any of the preceding Items wherein the lift mechanism comprises a scissor lift mechanism.

Item 11: In another embodiment, the present disclosure provides the method of any of the preceding Items further comprising detecting, by the controller, a failure of the motor automatically.

Item 12: In another embodiment, the present disclosure provides the method of any of the preceding Items wherein activating the electric power module comprises manually operating the controller, and wherein the controller is located on the platform and/or remotely from the lift device.

Item 13: In another embodiment, the present disclosure provides the method of any of the preceding Items wherein the electric power module comprises an auxiliary power module and outputs power only in the event of a failure of the motor.

Item 14: In another embodiment, the present disclosure provides a non-transitory computer readable storage medium having stored computer executable instructions for controlling a lift device having a lift mechanism movable to raise or lower a platform relative to a base, a manifold having a valve actuatable to deliver fluid to a hydraulic actuator configured to move the lift mechanism, a motor for driving a pump to deliver fluid to the manifold, an electric power module in communication with the manifold, and a controller in communication with the electric power module, wherein, the instructions when executed cause the controller to activate, in the event of a failure of the motor, the electric power module to actuate the valve of the manifold to enable gravity lowering of the platform by the lift mechanism from a first position to a second position below the first position.

Item 15: In another embodiment, the present disclosure provides the non-transitory computer readable storage medium of any of the preceding Items wherein the lift mechanism comprises a scissor lift mechanism.

Item 16: In another embodiment, the present disclosure provides the non-transitory computer readable storage medium of any of the preceding Items wherein the instructions when executed cause the controller to detect a failure of the motor automatically.

Item 17: In another embodiment, the present disclosure provides the non-transitory computer readable storage medium of any of the preceding Items wherein the controller is manually operable and is located on the platform and/or remotely from the lift device.

Item 18: In another embodiment, the present disclosure provides the non-transitory computer readable storage medium of any of the preceding Items wherein the valve comprises a coil powerable by the electric power module.

Item 19: In another embodiment, the present disclosure provides the non-transitory computer readable storage medium of any of the preceding Items wherein the second position is manually accessible from a surface supporting the base.

Item 20: In another embodiment, the present disclosure provides the non-transitory computer readable storage medium of any of the preceding Items wherein the electric power module comprises an auxiliary power module and outputs power only in the event of a failure of the motor.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, unless the context clearly indicates otherwise, the various features, elements, components, methods, procedures, steps, and/or functions of various implementing embodiments may be combined or utilized in any combination or combinations and/or may be performed in any order other than those specifically described herein to form further embodiments according to the present disclosure.

What is claimed is:

1. A lift device comprising:
a lift mechanism movable to raise or lower a platform relative to a base;
a manifold having a valve actuatable to deliver fluid to a hydraulic actuator configured to move the lift mechanism;
a motor for driving a pump to deliver fluid to the manifold;
an electric power module in communication with the manifold; and
a controller in communication with the electric power module, wherein, in the event of a failure of the motor, the controller is configured to activate the electric power module to actuate the valve of the manifold to enable gravity lowering of the platform by the lift mechanism from a first position to a second position below the first position.

2. The lift device of claim 1 wherein the lift mechanism comprises a scissor lift mechanism.

3. The lift device of claim 1 wherein the controller detects a failure of the motor automatically.

4. The lift device of claim 1 wherein the controller is manually operable and is located on the platform and/or remotely from the lift device.

5. The lift device of claim 1 wherein the valve comprises a coil powerable by the electric power module.

6. The lift device of claim 1 wherein the second position is manually accessible from a surface supporting the base.

7. The lift device of claim 1 wherein the electric power module comprises an auxiliary power module and outputs power only in the event of a failure of the motor.

8. The lift device of claim 1 wherein the drive motor is battery powered and a failure of the motor comprises insufficient battery charge, or the drive motor is gasoline powered and a failure of the motor comprises insufficient gasoline, or the drive motor is diesel fuel powered and a failure of the motor comprises insufficient diesel fuel.

9. A method for controlling a lift device having a lift mechanism movable to raise or lower a platform relative to a base, a manifold having a valve actuatable to deliver fluid to a hydraulic actuator configured to move the lift mechanism, a motor for driving a pump to deliver fluid to the manifold, an electric power module in communication with the manifold, and a controller in communication with the electric power module, the method comprising:
activating, in the event of a failure of the motor, the electric power module by the controller; and
actuating, by the electric power module, the valve of the manifold to enable gravity lowering of the platform by the lift mechanism from a first position to a second position below the first position.

10. The method of claim 9 wherein the lift mechanism comprises a scissor lift mechanism.

11. The method of claim 9 further comprising detecting, by the controller, a failure of the motor automatically.

12. The method of claim 9 wherein activating the electric power module comprises manually operating the controller, and wherein the controller is located on the platform and/or remotely from the lift device.

13. The method of claim 9 wherein the electric power module comprises an auxiliary power module and outputs power only in the event of a failure of the motor.

14. A non-transitory computer readable storage medium having stored computer executable instructions for controlling a lift device having a lift mechanism movable to raise or lower a platform relative to a base, a manifold having a valve actuatable to deliver fluid to a hydraulic actuator configured to move the lift mechanism, a motor for driving a pump to deliver fluid to the manifold, an electric power module in communication with the manifold, and a controller in communication with the electric power module, wherein, the instructions when executed cause the controller to:
activate, in the event of a failure of the motor, the electric power module to actuate the valve of the manifold to enable gravity lowering of the platform by the lift mechanism from a first position to a second position below the first position.

15. The non-transitory computer readable storage medium of claim 14 wherein the lift mechanism comprises a scissor lift mechanism.

16. The non-transitory computer readable storage medium of claim 14 wherein the instructions when executed cause the controller to detect a failure of the motor automatically.

17. The non-transitory computer readable storage medium of claim 14 wherein the controller is manually operable and is located on the platform and/or remotely from the lift device.

18. The non-transitory computer readable storage medium of claim 14 wherein the valve comprises a coil powerable by the electric power module.

19. The non-transitory computer readable storage medium of claim 14 wherein the second position is manually accessible from a surface supporting the base.

20. The non-transitory computer readable storage medium of claim 14 wherein the electric power module comprises an auxiliary power module and outputs power only in the event of a failure of the motor.
